(19) United States
(12) Patent Application Publication
(10) Pub. No.: US 2010/0008553 A1
(43) Pub. Date: Jan. 14, 2010

(54) Structured Medical Data Mapping System

(75) Inventor: Eric M. Holmstrom, Dexter, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/206,191

(22) Filed: Sep. 8, 2008

Related U.S. Application Data
(60) Provisional application No. 61/078,822, filed on Jul. 8, 2008.

(51) Int. Cl. G06K 9/00

(52) U.S. Cl. 382/128

(57) ABSTRACT

A system creates DICOM Structured Report (SR) mapping information for a medical software executable application using a GUI. A system enables use of DICOM compatible medical imaging related data by different computer systems. The system includes an input processor for receiving DICOM structured report representative data including multiple DICOM structured report data items comprising medical observations associated with medical images of a patient. A o user interface initiates generation of at least one display image including, first image elements representing the multiple DICOM structured report data items and second image elements. The second image elements represent candidate medical observation data items for storage in a repository. The at least one display image enables user selection of an individual DICOM structured report data item for association with a candidate medical observation data item to support automatic transfer of a value of the individual DICOM structured report data item to a data field for containing the candidate medical observation data item. A data interface automatically transfers a value of the individual DICOM structured report data item to a data field for containing the candidate medical observation data item in response to the user selection.

This is a non-provisional application of provisional application Ser. No. 61/078,822 filed Jul. 8, 2008, by E. Holmstrom.

### FIELD OF THE INVENTION

This invention concerns a system enabling use of DICOM compatible medical image related data by different computer systems using an interface enabling selection and automatic transfer of individual DICOM structured report data items to data fields for containing candidate medical observation data items.

### BACKGROUND OF THE INVENTION

Medical image related and other report data may be generated in a standardized format such as in a Digital and Imaging Communications in Medicine (DICOM) format suitable for exchange between different systems. A DICOM Structured Report (DICOM SR) format may be used to exchange hierarchical structured content, clinical terminology, and references to images, waveforms or other DICOM composite objects and to exchange image related measurement and calculation data among different systems. However, usage of the DICOM SR format is limited in known medical image data processing and reporting systems. DICOM SR requirements are at least in part, vague with room for interpretation error. The clinical findings from one source may be shared in a completely different way from clinical findings from a different source. This is due to the ambiguity of the DICOM standard. Consequently, medical software providers individually work with other providers that have a compatible product which generates a DICOM SR so the clinical findings that are provided in the DICOM SR are well understood and mapped to the correct locations in the destination system that wishes to use those shared findings.

However, it may take substantial time (weeks or even months) for one DICOM SR to be mapped into a target medical software product system. Also only a portion e.g., 70-80% of the clinical findings of a DICOM SR may have a designated location in the target medical software. One known system for acquiring clinical findings from a DICOM SR is burdened by a need to copy data directly from a store of the DICOM SR into another field on a worksheet or report. Similarly other known products are burdened by having to cut, copy, and paste data from a DICOM SR Viewer into a reporting system or a target software product. A system according to invention principles addresses these deficiencies and related problems.

### SUMMARY OF THE INVENTION

A system creates DICOM Structured Report (SR) mapping information for a medical software executable application using a DICOM SR Viewer Graphical User Interface (GUI) and updates existing DICOM SR mapping information during a patient study or study review, for example. A system enables use of DICOM compatible medical image related data by different computer systems. The system includes an input processor for receiving DICOM structured report representative data including multiple DICOM structured report data items comprising medical observations associated with medical images of a patient. A user interface initiates generation of at least one display image including, first image elements representing the multiple DICOM structured report data items and second image elements. The second image elements represent candidate medical observation data items for storage in a repository. Then at least one display image enables user selection of an individual DICOM structured report data item for association with a candidate medical observation data item to support automatic transfer of a value of the individual DICOM structured report data item to a data field for containing the candidate medical observation data item. A data interface automatically transfers a value of the individual DICOM structured report data item to a data field for containing the candidate medical observation data item in response to the user selection.

### BRIEF DESCRIPTION OF THE DRAWING

FIG. 1 shows a system enabling use of DICOM compatible medical image related data by different computer systems, according to invention principles.

FIGS. 2, 3 and 4 show a UI display image and submenu enabling a user to select and link a clinical measurement or observation data field type of a destination system with a user selected observation value of a source system, according to invention principles.

FIGS. 5, 6 and 7 show pertinent sections of corresponding FIGS. 2, 3 and 4 illustrating operation of UI the display image and submenu of FIGS. 2, 3 and 4, according to invention principles.

FIG. 8 shows a flowchart of a process performed by a system enabling use of DICOM compatible medical image related data by different computer systems, according to invention principles.

### DETAILED DESCRIPTION OF THE INVENTION

A system creates DICOM Structured Report (SR) mapping information linking a clinical measurement or observation data field type, of a destination medical executable application, with a user selected observation value of a source executable application using a DICOM SR Viewer Graphical User Interface (GUI). The system updates existing DICOM SR mapping information for a medical executable application live, during user initiated acquisition of a patient imaging study or performance of an image study review. The system enables a user (e.g. a physician) or a medical software vendor to create DICOM SR mapping information for medical software products (executable applications in combination with hardware) relatively quickly compared to known systems. The system also enables a user to create DICOM SR mapping information without delay in waiting for an entity to produce a DICOM SR with the data of interest to the user. A user interface in the system enables a user to assign findings, such as patient clinical measurements and observations received from a generic DICOM Structured Report viewing application (source) to a database that is used by a diagnostic reporting application. The diagnostic reporting application uses clinical measurement and observation values in performing calculations and generating a final report for an image study of a patient that identifies individual clinical measurement and observations that are assigned via the user interface.

DICOM SR data as used herein comprises a file of text data including image related, findings, observations and measurements received from an imaging modality device such as an Ultrasound or other imaging modality device or PACS system. A processor as used herein is a device for executing stored machine-readable instructions for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

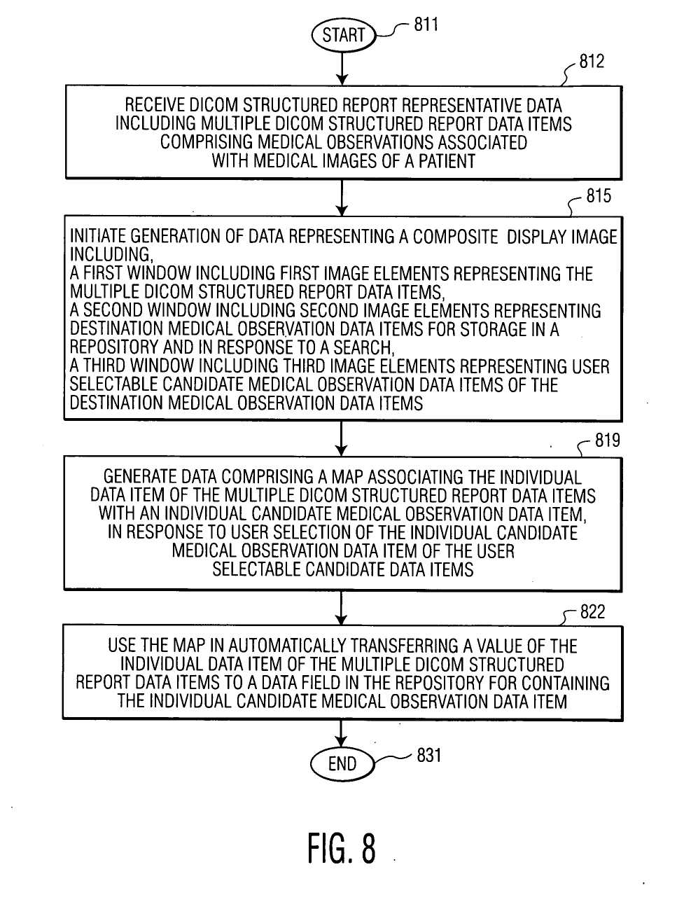

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 8) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

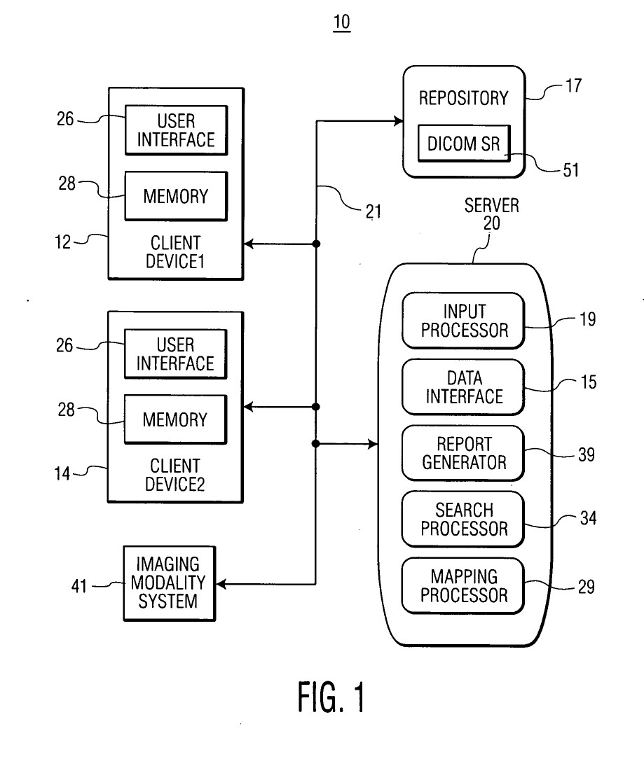

FIG. 1 shows system 10 enabling use of DICOM compatible medical image related data by different computer systems. System 10 includes processing devices (e.g., workstations or portable devices such as notebooks, Personal Digital Assistants, phones) 12 and 14 that individually include a user interface 26 and memory 28. System 10 also includes at least one repository 17, imaging modality device 41 (such as an MR (magnetic resonance), CT scan, X-ray or US (Ultrasound) device) and server 20 intercommunicating via network 21. User interface 26 provides data representing display images comprising a Graphical User Interface (GUI) for presentation on processing devices 12 and 14. At least one repository 17 stores DICOM SR 51 data and medical image studies for multiple patients. A medical image study individually includes multiple image series of a patient anatomical portion which in turn individually include multiple images and sometimes DICOM structured reports. Server 20 includes search processor 34, report generator 39, data interface 15, mapping processor 29 and input processor 19.

Input processor 19 receives DICOM structured report (SR) 51 representative data including multiple DICOM structured report data items comprising medical observations associated with medical images of a patient. User interface 26 initiates generation of at least one display image including, first image elements representing the multiple DICOM structured report data items and second image elements representing candidate medical observation data items for storage in repository 17. Then at least one display image enables user selection of an individual DICOM structured report data item for association with a candidate medical observation data item to support automatic transfer of the individual DICOM structured report data item to a data field for containing the candidate medical observation data item. Mapping processor 29 generates data comprising a map associating the individual DICOM structured report data item with a candidate medical observation data item to support the automatic transfer. Data interface 15 automatically transfers a value of the individual DICOM structured report data item to a data field for containing the candidate medical observation data item in response to the user selection.

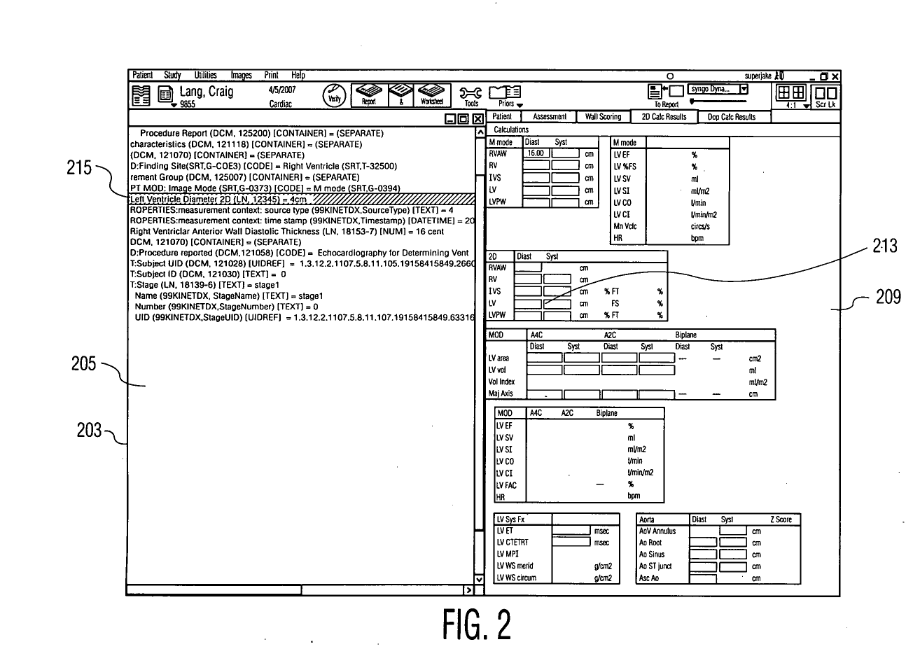

FIG. 2 shows UI display image 203 provided by user interface 26 (FIG. 1) enabling a user to select and link a clinical measurement or observation data field type of a destination system with a user selected observation value of a source system. Display image 203 enables a user to quickly link clinical findings from DICOM SR 51 to a medical software product proprietary database and also update existing DICOM SR mappings for the linked clinical findings with a fixed association. System 10 allows a user to take an existing DICOM SR created by a product and create a mapping file for a medical software product database, or a data management system that records clinical findings for reporting or another purpose. System 10 also allows a user, during acquisition of a patient imaging study, to review data on display images provided by user interface 26 that was not mapped and to link the data to a database or a data management system field and continue review and processing of the image study. In response to user initiated generation of mapping information, system 10 automatically updates previously created SR mapping information substantially immediately. Thereby, the next time an image study is acquired from an imaging modality device that uses the same DICOM defined clinical finding identifiers, image data is imported automatically without interruption.

System 10 advantageously reduces delay in mapping of clinical findings from DICOM SR 51 to a proprietary medical executable application by enabling relatively quick and efficient integration of DICOM SR 51 with other medical executable applications employed by a medical review station or reporting system. System 10 also enables a user to update DICOM SR mappings provided by a manufacturer. System 10 provides simplified operation in response to user command via a user interface display image and data entry device (e.g., mouse) and a context related menu of target measurements and observations available for user selection and initiation of mapping information creation. System 10 enables a user to readily identify and parse through clinical findings that were not able to be imported automatically upon acquisition of DICOM SR 51 and to import them in response to user command. Report generator 39 in system 10 initiates generation of an image examination report and data interface 15 provides a notification message to a user indicating to a user that missing clinical findings need to be automatically imported.

In one embodiment, system 10 advantageously relatively quickly creates DICOM SR mapping information before an image study is acquired and updates DICOM SR mapping information during acquisition of an image study with a DICOM SR Viewer. A user is able to substantially immediately link a clinical finding item from a DICOM SR with a clinical item data field used by a product executable application and to update a mapping file so that the clinical finding item appears and continues to appear for future image study reports. Data interface 15 in conjunction with User Interface (UI) 26 imports unsupported or unmapped DICOM SR data into report generator 39 for generating a medical imaging study report and reduces burden on a user providing reduced need for typing and quicker reporting avoiding a need for copying and pasting. The system provides enhanced reporting functionality and quicker access to DICOM SR data that has not been mapped directly into a software product upon receiving a DICOM SR. The system enables access to a DICOM SR using a DICOM SR viewer and imports clinical image related measurement data in response to a reduced number of user commands to facilitate quick and accurate diagnosis.

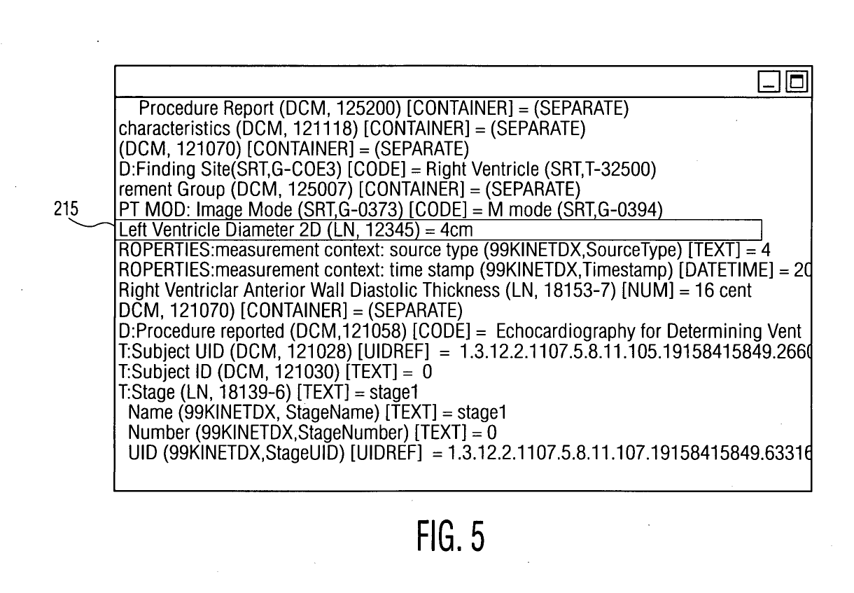

FIGS. 2, 3 and 4 show a UI display image and submenu enabling a user to select and link a clinical measurement or observation data field type of a destination system with a user selected observation value of a source system. FIGS. 5, 6 and 7 show pertinent sections of corresponding FIGS. 2, 3 and 4. User interface 26 (FIG. 1) presents source DICOM SR 51 data in a structured format in DICOM viewing application window 205 (FIG. 2) in display image 203 on workstation 12. DICOM SR data in window 205 comprises a file of text data including image related, findings, observations and measurements received from an imaging modality device such as an Ultrasound or other imaging modality device or from storage in a PACS system, for example. Image window 209 in display image 203 shows DICOM SR data in a destination proprietary structured data format used for creation of a structured patient specific imaging examination report in a user system. In operation of the system, a physician sees that an observation value (e.g., Left Ventricle (LV) diameter) is absent from data field 213 in the proprietary structured data format of window 209. The physician selects (e.g., by right mouse click) the Left Ventricle diameter data item 215 in DICOM SR 51 data in window 205.

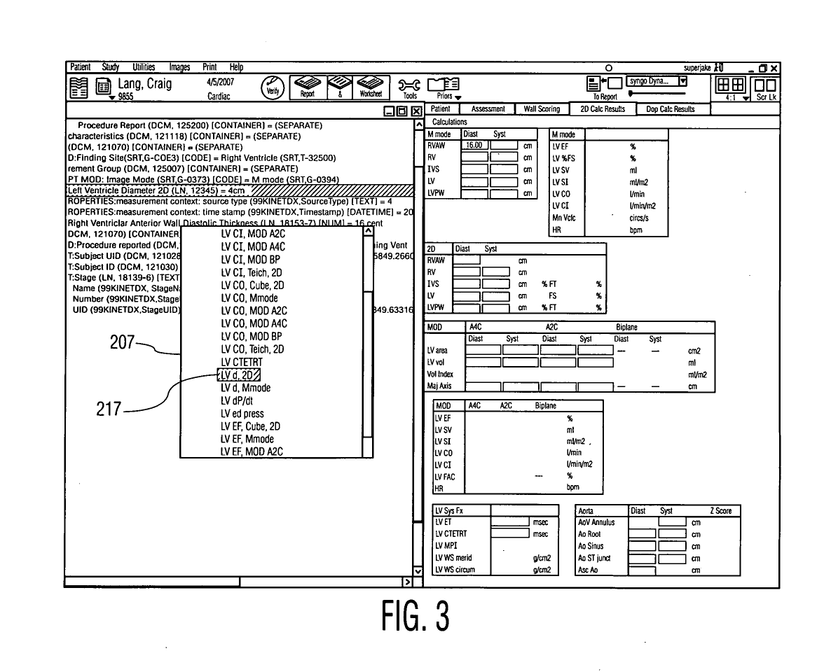

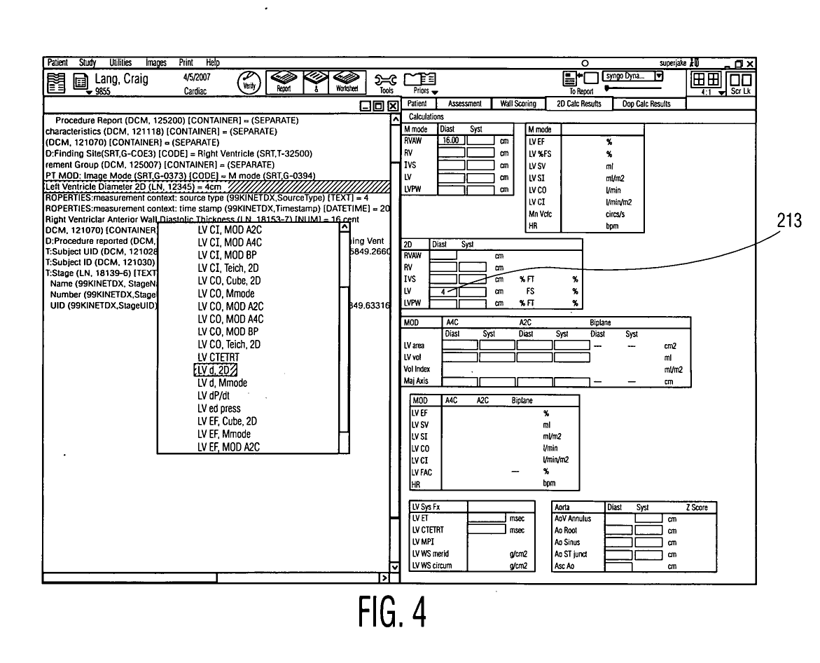

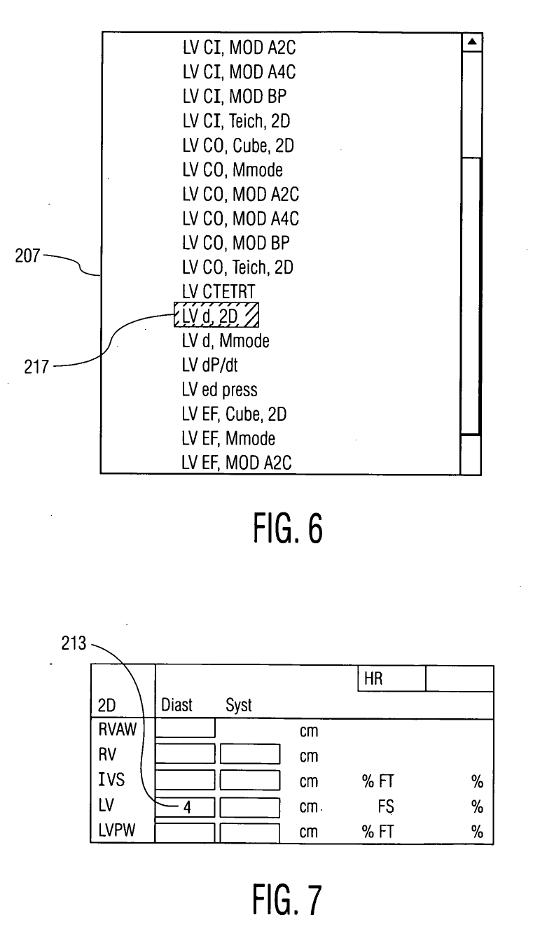

In response to the selection of item 215 (FIGS. 2 and 5) in window 205, user interface 26 initiates generation of context dependent menu 207 of FIG. 3 presenting a candidate list of destination data fields in the proprietary structured data format comprising data elements and fields at least partially displayed in window 209 (FIG. 2). A user selects destination data field 217 (FIGS. 3 and 6) in context dependent menu 207 (and corresponding to data field 213 FIG. 2) to map data item 215 into. Thereby data item 215 is henceforth automatically mapped to data field 213. The candidate list of destination data fields of menu 207 comprises a subset of data fields of the proprietary structured data format that are associated with selected data item 215. In another embodiment, the candidate list of destination data fields of menu 207 comprises substantially all the data fields of the proprietary or standard formatted structured data format and the data fields are grouped in medically related sets. In operation, data item 215 (LV Diameter 4cm) is mapped to data item 213 as illustrated in FIG. 4 and FIG. 7.

In response to user mapping of received data item 215 to destination data field 213 via context menu 207, data interface 15 automatically transfers a value of individual DICOM structured report data item 215 to data field 213. Context menu 207 is used in conjunction with selection of text in DICOM SR viewer application window 205 to enable a user to select a measurement or observation data field in which a selected measurement or observation value is to be displayed in window 209. Display image 209 is updated when measurement or observation data items are mapped in response to user command. Further, display image 203 no longer indicates a mapped measurement or observation as not being mapped in response to configuration of display image 203 to indicate unmapped data. Display image 203 presents and hides already mapped clinical image related measurements and observations in response to user command.

System 10 supports user initiated DICOM SR clinical observation assignments in a generic DICOM SR Viewer in response to a current imaging study context. A UI device (e.g., a mouse, keyboard etc.) enables a user to initiate commands to provide a candidate list of measurements and/or observation data field items that a DICOM SR selected value is communicated to. The list of measurements and observations belong to a current image study context (e.g. cardiac measurements are in a list for an Adult Heart study), for example.

In exemplary operation, a Cardiac Ultrasound laboratory acquires a new Ultrasound (US) machine. An ultrasound imaging study is performed on a man that involves making 50 image related measurements using the US machine and the resulting measurements and study comprising a DICOM Structured Report (SR) is sent to a reporting workstation comprising user interface 26 (FIG. 1). During the review of the study images at the reporting workstation a physician notices that a measurement is needed, the Left Ventricular Diameter (LVd.) did not appear on a worksheet with the other measurements. The physician opens a generic DICOM SR viewer application window and selects a DICOM SR via the window that was sent with the images from the US machine. The physician searches the DICOM SR for the word LV until the term LVd is found and selects a 15mm value. In response to user selection of the value (e.g., via a mouse right button click), a menu that contains Cardiac related measurements and observations is advantageously derived in response to Study Description (Adult Heart) and category (a cardiac study) provided based on pre-configuration of the image Study Description. The physician selects an LVd. item in the menu and the 15mm value appears in a worksheet, transfers to a report, is saved in the mapping mechanism for future Structured Reports and is saved in repository 17 with the rest of the measurements.

In a further illustration of operation, a manufacturer user creates an application that makes mapping files for importing DICOM SR data into manufacturer proprietary executable application and database for use in generating an imaging examination report for a patient. The application includes a DICOM SR Viewer that has a mouse interface used to assign mappings to manufacturer proprietary executable application and database by simple clicking on parsed DICOM SR data field items. The mapping application includes manufacturer application data fields allowable as DICOM SR mapping destinations that are available via a menu displayed in response to data field item selection by a user. A DICOM SR viewing application portion of SR mapping mechanism is configured to automatically remove data items that are already mapped or to leave the data items there and identify that the data items have been mapped and the destination to which they have been mapped. In response to hovering a cursor over a data field item in the DICOM SR viewing application window, a message is displayed indicating a destination field it is mapped to and including a link enabling further analysis of the mapping that was previously made.

A user obtains a DICOM SR including examples of data items that need to be mapped to a manufacturer proprietary executable application installed at a customer site. A user opens the DICOM SR with a DICOM SR Mapping application and selects a destination data field item for individual SR observations or data elements of interest via a mapping menu. In response to user selection of a destination data field item, a map associated with a specific user of the DICOM SR and particular proprietary manufacturer application associated with a particular manufacturer product and product version is updated to indicate a source data field item in the SR and a corresponding new destination field item in the particular manufacturer product. Upon completion of mapping the individual data field items, the mapping is tested and delivered. Measurements, observations, report data, finding data, and any other data that was mapped now automatically imports when it matches the criteria in the mapping file (e.g., mapping data for a particular product version, manufacturer).

In another illustration of operation, a customer of a manufacturer proprietary executable application and database for use in generating an imaging examination report for a patient performs DICOM SR mapping. A customer specific DICOM SR is mapped using a non-live (e.g., test) environment for generation of a customer specific imaging examination report and worksheet for use in a live (non-test) environment. A customer performs mappings as previously described to generate a map file linking DICOM SR data field items to corresponding items in a customer specific report and activates the generated map file and imports it into an active live executing manufacturer proprietary report generation application. In response to the activation, DICOM SR data field items are mapped from a customer imaging system to the manufacturer proprietary report generation application and database. The customer communicates the map file to the manufacturer enabling the manufacturer to automatically provide the map file to other customers. Thereby, data items mapped in the mapping file that match the mapping file criteria are automatically imported into the other customer systems.

System 10 also enables update (e.g., by a factory or customer user) of a DICOM SR map file previously generated by a manufacturer. A manufacturer desiring to map data items provided in an altered DICOM SR employs system 10 to update a previously generated map file. A user employs a DICOM viewer application window presenting the altered DICOM SR in a composite image together with a window presenting a destination report generator window showing destination data field items. System 10 automatically (or in response to user command in another embodiment) loads the altered DICOM SR, destination report and previous map file data and indicates (e.g., by highlighting) which items in the altered DICOM SR are not linked to destination data field items (or indicates destination data field items that are not linked with source data field items that are present and available). A user maps the non-linked data items in the manner previously described and stores an updated map file associated with the particular DICOM SR generating system and destination system involved for use in automatic DICOM SR data exchange with a destination report generation application, for example. The system also stores a previous map file version.

A customer employs the map file update process in response to determining individually identified DICOM SR data items are not being imported into a report generation application. Upon generation and activation of the updated map file, data items from the DICOM SR are automatically imported into the report generation application and the DICOM SR viewing window no longer identifies data items as not being imported. The map file is stored for future use with the particular DICOM SR generating system and particular destination report generating applications concerned.

FIG. 8 shows a flowchart of a process performed by a system enabling use of DICOM compatible medical image related data by different computer systems. In step 812, following the start at step 811, input processor 19 (FIG. 1) receives DICOM structured report representative data (e.g., a DICOM SR compatible data structure) including multiple DICOM structured report data items comprising medical observations associated with medical images of a patient. In step 815, user interface 26 initiates generation of data representing at least one display image including, first image elements representing the multiple DICOM structured report data items and second image elements representing destination medical observation data items for storage in repository 17. Repository 17 comprises a database including data fields for containing candidate medical observation data items. Search processor 34 searches the DICOM structured report data items in response to user entered text, to find a set of candidate desired DICOM structured report data items to display to a user for user selection of an individual DICOM structured report data item. In 12 response user selection of an individual data item of the multiple DICOM structured report data items and the search, the at least one display image includes third image elements representing user selectable candidate medical observation data items of the destination medical observation data items. Further, in response to user selection of the individual data item of the multiple DICOM structured report data items, the individual data item is removed from the display of the DICOM structured report data items.

Then at least one display image comprises a single composite display image including, the first image elements presented in a first window, the second image elements presented in a second window and the third image elements presented in a third window. The candidate medical observation data items may comprise either a subset, or a list, of the destination medical observation data items related to the individual data item of the multiple DICOM structured report data items, the subset being generated based on an automatically performed text matching search.

In step 819, mapping processor 29 generates data comprising a map associating the individual data item of the multiple DICOM structured report data items with an individual candidate medical observation data item, in response to user selection of the individual candidate medical observation data item of the user selectable candidate data items. In step 822, data interface 15 uses the map in automatically transferring a value of the individual data item of the multiple DICOM structured report data items to a data field in the repository for containing the individual candidate medical observation data item. Input processor 19 further receives a second DICOM structured report. Data interface 15 automatically identifies the individual DICOM structured report data item in data representing the second DICOM structured report and automatically transfers the individual DICOM structured report data item identified in the second DICOM structured report to a data field in repository 17 for containing the candidate medical observation data item in response to the user selection. The process of FIG. 8 terminates at step 831.

The systems and processes of FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 accelerates DICOM SR mapping generation and update in a test and non-test environment during image study generation in a patient examination, for example. The system is useable in any industry that has a defined mechanism for sharing clinical data in a structured format that happens to be ambiguous and product specific. Mappings of the structured data may be created for a specific product and later updated in response to data not being mapped into a receiving system. The processes and applications may, in alternative embodiments, be located on one or more (e.g., distributed) processing devices accessing a network linking the elements of FIG. 1. Further, any of the functions and steps provided in FIGS. 1-8 may be implemented in hardware, software or a combination of both and may reside on one or more processing devices located at any location of a network linking the elements of FIG. 1 or another linked network, including the Internet.

What is claimed is:

1. A system enabling use of DICOM compatible medical imaging related data by different computer systems, comprising:
an input processor for receiving DICOM structured report representative data including a plurality of DICOM structured report data items comprising medical observations associated with medical images of a patient;
a user interface for initiating generation of data representing at least one display image including,
first image elements representing said plurality of DICOM structured report data items and
second image elements representing candidate medical observation data items for storage in a repository, said at least one display image enabling user selection of an individual DICOM structured report data item for association with a candidate medical observation data item to support automatic transfer of a value of said individual DICOM structured report data item to a data field in a data repository for containing said candidate medical observation data item; and
a data interface for automatically transferring a value of said individual DICOM structured report data item to a data field in the repository for containing said candidate medical observation data item in response to said user selection.

2. A system according to claim 1, wherein
the data repository comprises a database including the data field for containing said candidate medical observation data item and
said DICOM structured report comprises a DICOM SR compatible data structure.

3. A system according to claim 1, including
a search processor for searching said plurality of DICOM structured report data items in response to user entered text, to find a set of candidate desired DICOM structured report data items to display to a user for said user selection of said individual DICOM structured report data item.

4. A system according to claim 1, wherein
in response to user selection of the individual data item of the multiple DICOM structured report data items, said individual data item is removed from a display of said DICOM structured report data items.

5. A system according to claim 1, wherein
said input processor receives a second DICOM structured report and
said data interface automatically identifies said individual DICOM structured report data item in data representing said second DICOM structured report and automatically transfers said individual DICOM structured report data item identified in said second DICOM structured report to a data field in a repository for containing said candidate medical observation data item in response to said user selection.

6. A system enabling use of DICOM compatible medical imaging related data by different processing systems, comprising:
an input processor for receiving DICOM structured report representative data including a plurality of DICOM structured report data items comprising medical observations associated with medical images of a patient;
a user interface for initiating generation of data representing at least one display image including,
first image elements representing said plurality of DICOM structured report data items,
second image elements representing destination medical observation data items for storage in a repository and
in response to user selection of an individual data item of said plurality of DICOM structured report data items, third image elements representing user selectable candidate medical observation data items of said destination medical observation data items;
a mapping processor for generating data comprising a map associating said individual data item of said plurality of DICOM structured report data items with an individual candidate medical observation data item, in response to user selection of said individual candidate medical observation data item of said user selectable candidate data items; and
a data interface for using said map in automatically transferring a value of said individual data item of said plurality of DICOM structured report data items to a data field in the repository for containing said individual candidate medical observation data item.

7. A system according to claim 6, wherein
said at least one display image comprises a single composite display image.

8. A system according to claim 7, wherein
said first image elements are presented in a first window in said composite display image.

9. A system according to claim 8, wherein
said second image elements are presented in a second window in said composite display image.

10. A system according to claim 9, wherein
said third image elements are presented in a third window in said composite display image.

11. A system according to claim 6, wherein
said candidate medical observation data items are a subset of said destination medical observation data items related to said individual data item of said plurality of DICOM structured report data items, said subset being generated based on an automatically performed text matching search.

12. A system according to claim 6, wherein
said candidate medical observation data items comprise a list of said destination medical observation data items related to said individual data item of said plurality of DICOM structured report data items.

13. A system enabling use of DICOM compatible medical image related data by different executable applications, comprising:
an input processor for receiving DICOM structured report representative data including a plurality of DICOM structured report data items comprising medical observations associated with medical images of a patient;
a user interface for initiating generation of data representing a composite display image including,
a first window including first image elements representing said plurality of DICOM structured report data items,
a second window including second image elements representing destination medical observation data items for storage in a repository and
in response to user selection of an individual data item of said plurality of DICOM structured report data items, third image elements representing user selectable candidate medical observation data items of said destination medical observation data items;
a mapping processor for generating data comprising a map associating said individual data item of said plurality of DICOM structured report data items with an individual candidate medical observation data item, in response to user selection of said individual candidate medical observation data item of said user selectable candidate data items; and
a data interface for using said map in automatically transferring a value of said individual data item of said plurality of DICOM structured report data items to a data field in the repository for containing said individual candidate medical observation data item.

14. A system according to claim 13, wherein
said third image elements are presented in a third window in said composite display image.
